(19) United States
(12) Patent Application Publication
(10) Pub. No.: US 2016/0239495 A1
(43) Pub. Date: Aug. 18, 2016

(54) RATING THE RELEVANCE OF NEWS STORIES FOR RECIPIENTS OF A NEWS FEED

(71) Applicant: ACQUIRE MEDIA VENTURES INC., Roseland, NJ (US)

(72) Inventors: Lawrence C. Rafsky, Livingston, NJ (US); Jonathan Alan Marshall, Montclair, NJ (US); Raymond Sun, East Brunswick, NJ (US)

(21) Appl. No.: 14/793,831

(22) Filed: Jul. 8, 2015

Related U.S. Application Data
(60) Provisional application No. 62/115,260, filed on Feb. 12, 2015.

(51) Int. Cl. G06F 17/30; H04L 29/06; H04L 29/08

(52) U.S. Cl. CPC G06F 17/3053; H04L 67/10; H04L 67/02; H04L 67/42

(57) ABSTRACT

A server may receive a new story. The server may calculate a base score for the new story. The server may identify a set of stories received prior to the new story with which the new story overlaps. For each story in the set of stories, the server may compute a current score that the story in the set of stories would receive if the story in the set of stories were received at the same time as the new story. The server may identify a lower bound story in the set of stories having an original score and having a current score nearest to and lower than the base score for the new story and an upper bound story in the set of stories having an original score and having a current score nearest to and higher than the base score for the new story. The server may assign a score to the new story based on the original score of the lower bound story and the original score of the upper bound story.

### CROSS-REFERENCE TO RELATED APPLICATIONS

This application claims the benefit of U.S. provisional patent application No. 62/115,260 filed Feb. 12, 2015, the disclosure of which is incorporated herein by reference in its entirety.

### TECHNICAL FIELD

Examples of the present disclosure relate to a method and system which rates stories with a relevance score before passing the stories along to the client over a network.

### BACKGROUND

Generating a list of top news stories and, more particularly, identifying which news articles are “top,” or currently most relevant, is a difficult problem to solve. When attempting to generate a list of top news articles, populating the list with only articles about the most pressing topic defeats the purpose of having a list. As news flow becomes thicker and thinner throughout the day, a metric other than real-time is needed to determine how relevant a news story is to a reader at any given point in time, since stories quickly rise to and decline from relevance when news traffic is thick while maintaining a more persistent level of relevance at slow news hours such as the very early morning. Real-time calculation of news relevance is ill-suited to adapt to fluctuations in news flow. Minimizing cost for the client is desirable. Ideally, a news list based on relevance transmitted to a client would have the most relevant news stories the client could receive while minimizing the cost that the client pays for premium news wires.

Rating a news story with a score based on newsworthiness and relevance should accurately reflect which stories are currently more relevant while ensuring that newly assigned scores do not contradict older scores. In other words, the relevance score of a newer story should accurately reflect how relevant the newer story is relative to an older story. However, the relevance of an older story can decline with the emergence of new story topics. Unfortunately, the relevance score assigned to an older story is immutable once the story is transmitted to the client. A relevance score cannot be changed after it is associated with the older story because the older story would be in the possession of a client after being transmitted. Accordingly, it becomes more difficult to keep relevance scores for stories published later in a day consistent with scores for stories published earlier in the day.

### SUMMARY

The above-described problems are remedied and a technical solution is achieved in the art by providing a method and system which rates stories with a relevance score before passing the stories along to the client over a network. A server may receive a new story. The server may calculate a base score for the new story. The server may identify a set of stories received prior to the new story with which the new story overlaps. For each story in the set of stories, the server may compute a current score that the story in the set of stories would receive if the story in the set of stories were received at the same time as the new story. The server may identify a lower bound story in the set of stories having an original score and having a current score nearest to and lower than the base score for the new story and an upper bound story in the set of stories having an original score and having a current score nearest to and higher than the base score for the new story. The server may assign a score to the new story based on the original score of the lower bound story and the original score of the upper bound story.

In an example, when there are no identified stories in the set of stories that overlap with the new story, the server may assign the base score of the new story to the new story. When there is an identified lower bound story but no identified upper bound story, the server may assign a score to the new story that is higher than the original score of the identified lower bound story. When there is an identified upper bound story but no identified lower bound story, the server may assign a score to the new story that is lower than the original score of the identified upper bound story. When there is an identified upper bound story and an identified lower bound story, and the original score of the identified upper bound story is larger than the original score of the identified lower bound story, the server may assign a score to the new story that is lower than the original score of the identified upper bound story but higher than the original score of the identified lower bound story.

When there is an identified upper bound story and an identified lower bound story, and the original score of the identified lower bound story is larger than the original score of the identified upper bound story, the server may assign a score to the new story that is larger than the original score of the identified lower bound story. In another example, when there is an identified upper bound story and an identified lower bound story, and the original score of the identified lower bound story is larger than the original score of the identified upper bound story, the server may assign a score to the new story that is the mean of the original score of the identified lower bound story and the original score of the upper bound story.

In an example, the server attempting to identify a lower bound story and an upper bound story may further comprise the server identifying all stories in the set of stories having an overlap with the new story. The server may assign the score to the new story based on the original scores of the stories in the set of stories having an overlap with the new story.

In an example, the server assigning a score to the new story based on the original score of the lower bound story and the original score of the upper bound story may further comprise the server assigning a score to the new story based on a weighting function applied to the original score of the lower bound story and to the original score of the upper bound story.

In an example, the server may add the new story and the assigned score of the new story to a list of relevant stories. In an example, the server may receive a request from a client for the list of relevant stories. In another example, the server may initiate pushing to the client the list of relevant stories. In an example, the server initiating pushing to the client the list of stories may be a scheduled event or triggered event. The server may transmit to the client the list of relevant stories in order from the story having the highest assigned score to the story having the lowest assigned score.

In an example, the list of relevant stories may pertain to a topic. In an example, the list of relevant stories may be generated over a period of time.

In an example, the list of relevant stories may be taken from a set of candidate news feeds (e.g., low cost or free news feeds). In an example, the received prior set of stories may be taken from a set of driver news feeds (e.g., premium cost news feeds).

In an example, a score for a story may be calculated or assigned based on a plurality of terms appearing most prominently in the story. In an example, the score for the story may be equal to a score corresponding to scores of the sum of the plurality of terms appearing most prominently in the story.

In an example, an overlap between the new story and a story in the set of stories may be an overlap of one or more terms in a set of key terms appearing most prominently in the new story and the story in the set of stories.

In an example, a score for a term appearing most prominently in a story may be decreased each time a story is received.

### BRIEF DESCRIPTION OF THE DRAWINGS

The present invention may be more readily understood from the detailed description of an exemplary embodiment presented below considered in conjunction with the attached drawings and in which like reference numerals refer to similar elements and in which:

FIG. 1 is a block diagram of an example system in which examples of the present disclosure may operate.

FIG. 2 is a table illustrating an example of assigning to a news story a score that maintains relative consistency with the scores assigned to prior news stories on a topic.

FIGS. 3A and 3B are a flow diagram illustrating an example of a method to find currently relevant news stories from a plurality of news feeds and arrange them into a list of stories considered to be both newsworthy and relevant at the time of viewing, to be delivered to clients over a network.

FIG. 4 illustrates a diagrammatic representation of a machine in the exemplary form of a computer system within which a set of instructions, for causing the machine to perform any one or more of the methodologies discussed herein, may be executed.

It is to be understood that the attached drawings are for purposes of illustrating the concepts of the invention and may not be to scale.

### DETAILED DESCRIPTION

Embodiments of the present disclosure may calculate and may assign relevance scores to stories that more accurately reflect relevance of the stories throughout the course of the day, even when compared to older stories with older scores. Embodiments of the present disclosure may rate stories with a relevance score before passing the stories along to the client.

Embodiments of the present disclosure may ensure that relevance scores remain more consistent throughout the day: stories that hit the press later in the day may have their relevance scores calculated relative to the scores of prior stories. In other words, newer stories may have their scores calibrated in relation to the scores of older stories assigned at the time of their publications.

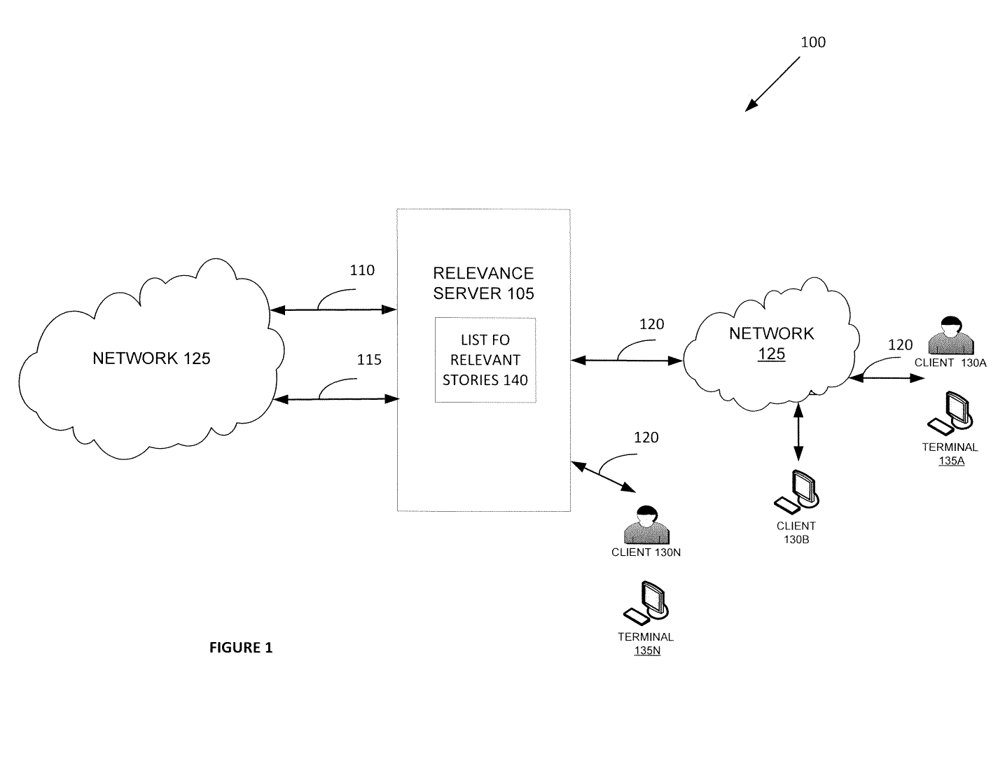

FIG. 1 is a block diagram of an example system 100 in which examples of the present disclosure may operate. A relevance server 105 may be configured to receive news stories, for example, over a network 125, which may be, but is not limited to, the Internet. One or more clients 130a-130n may receive on a terminal (e.g., 135a) e.g., over the network 125 or directly from a terminal 135n communicatively connected to the relevance server 105, a set of relevant news stories 120. As used herein, a client (e.g., 130a) may be, for example a human user, operator, or customer of the system 100, or may be a non-terminal automated client application (e.g., 130b) as part of a client server relationship communicatively connected to the network 125 or to the top news server 105 using an application programming interface (API).

In another example, the server 105 may initiate pushing to the client (e.g., 130a) the set of relevant news stories. In an example, the server 105 initiating pushing to the client (e.g., 130a) the set of relevant stories may be a scheduled event or triggered event. In another example, the one or more clients 130a-130n may receive on the terminal (e.g., 135a) e.g., over the network 125, a set of relevant news stories related to a topic 120. In another example, the one or more clients 130a-130n may receive on the terminal (e.g., 135a) e.g., over the network 125, a set of relevant news stories related to a topic 120 for a time interval, e.g., collected over the course of a day.

The scoring functionality of the relevance server 105 is to rate stories with a relevance score before passing the stories along to the client (e.g., 130a). In an example, the relevance server 105 may calculate the relevance score using a set of premium wires (e.g., Associated Press), which may collectively carry a more comprehensive, more balanced, and deeper set of news stories. However, a relevance score cannot be changed after it is attached to a story, because the story is in possession of the clients 130a-130n after being transmitted. As a result, it becomes more difficult to keep relevance scores for stories published later in the day consistent with scores for stories published earlier in the day.

The system 100 may be configured to ensure that relevance scores remain consistent throughout the day: stories that hit the press later on in the day may have their relevance scores calculated relative to the scores of prior stories. In other words, newer stories may have their scores calibrated in relation to the scores of older stories assigned at the time of publications of the older stories.

In one example, each news story may contain a series of terms which may be selected to mark the topics that the news story covers. These terms are collectively dubbed the story signature of that story. As used herein, the term “story signature” may refer to a short set of words or phrases, sometimes truncated or stemmed, that represent the key concepts in a story. The short set of words or phases may, in an example, comprise 5 to 15 constituents. The short set of words or phases are often made up of two different sub-signatures: A “headline signature”, which derives the short set of words or phases from headlines, and “cluster signature”, derives the short set of words or phases from body of a story. As used herein, the term overlap may refer to a measure of the degree that two stories are on the same topic by looking at the overlap of components of the story signature. As used herein, the short set of words or phrases that represent the key concepts in a story may be referred to as the key terms of the story signature, headline signature, or cluster signature.

The news stories may be separated into two categories: “topic-driving” feeds 110 from the premium wires and lower-priced or free “candidate” feeds 115. In one example, the system 100 may employ the “topic-driving” feeds 110, which are pre-determined to be representative feeds of what news topics are generally considered newsworthy. Each individual term in the story signature may have its own score, which may increase each time a news story with that term is received. Term scores may be set to decay when each new story is received, so that less-frequently received terms become less relevant. Whenever a news story comes into the system 100, the news story may be rated in relevance based on its story signature; i.e., the news story may be assigned a relevance score which is the sum of all its story signature term scores. The relevance score may then be attached to the story (e.g., using an XML tag) and then be transmitted to the client (e.g., 130a). Stories which have been transmitted may be recorded along with their relevance scores so that newer stories may have their scores adjusted to be consistent with those of older stories.

There are two separate mechanisms employed by the system 100 to ensure that a relevance score assigned to a news story accurately represents the relevance of the news story relative to other news stories published during a time interval, e.g., during the course of a day. The first mechanism is term score decay, which decreases the score of a term by a small percentage each time a story is published. This ensures that a topic which was once highly relevant can be recognized as decreasing in relevance in relation to other received news stories.

However, decay alone cannot ensure that relevance score are accurate when compared to other relevance scores from different parts of the day, which is why score adjustment may be employed by the system 100. Relevance scores of newer stories may be scaled by the system 100 so that newsworthy stories which are received later in the day have assigned relevance scores which reflect their relevance relative to stories transmitted earlier in the day.

The system 100 may be configured to scale a relevance score assigned to a story by comparing the current scores of older stories (i.e., the scores that the older stories would receive if they were republished) to the scores which the older stories were assigned when the older stories were transmitted. Specifically, the system 100 may be configured to examine the set of all older stories and narrow the set down to a set of two or fewer stories having an upper bound in relevance and a lower bound in relevance for assigning a relevance score to the new story. If the only stories that overlap have lower current scores, the score of the story with the highest relevance score may be selected to be the lower bound score; the new story may receive a relevance score that is at least as high as that upper bound score. The inverse holds true if only stories with higher current scores exist. In ideal cases, there are two stories close in current relevance score to the new story to serve as an upper bound score and a lower bound score, respectively. However, since stories can have both higher relevance than current scores (if they are no longer relevant) and higher current scores than top-scores (if one story signature term in the story began trending because of a different topic), the older story with the higher current score may have its relevance score employed by the system 100 as an upper bound, and the closest older story with a lower current score which does not create an impossible set of bounds (i.e., a higher relevance score than the upper bound) may be employed by the system 100 as a lower bound score. In one example, subsequently, the relevance scores of transmitted stories may be averaged to produce a relevance score for the new story. This prevents the relevance scores of stories from inflating wildly, while ensuring that a story assigned relevance score reflects its relevance relative to other stories that have already been assigned immutable relevance scores.

There are other approaches to ordering the scores which the system 100 may employ. Alternate methods for recalibrating the assigned relevance score of a new story may include employing the average percent difference between all assigned scores and current scores to determine how to scale the assigned score for a new story. Additionally, it is possible to calculate the assigned score of a new story by simply selecting the two stories with overlapping terms closest to the score of the new story in current score and averaging the assigned scores of the two stories to produce a result (while giving the new story an unaltered score if no two stories exist). These approaches provide the client (e.g., 130a) with a more accurate representation of the relevance of a new news story relative to earlier news stories than a raw score, without changing any relevance scores already provided to the clients 130a-130n earlier in the day.

Duplicate stories, unless they have new information, are generally assigned lower scores than their original counterparts. The system 100 may also employ the candidate feed/topic-driving feed split to use more expensive but reliable news wires to gauge which topics are truly important before transmitting stories pertaining to a topic from more affordable wires. Finally, the system 100 may employ the publication of each new story as its metric for decaying the story signature term scores for the new story, ensuring that the system 100 may handle variable story volume at different times.

More particularly, the system 100 may keep track of stories that were transmitted using the one or more candidate feeds 115 feed during a day (or other interval), along with relevance scores assigned to the stories. When a new story arrives, the system 100 may assign to the new story a relevance score value that reflects the importance of the new story relative to prior stories. The prior stories are less important than they were originally, because of the passage of time. The score values assigned to the prior stories cannot be changed, because there is no mechanism to do so in a feed. Instead, the system 100 may assign a new score to the new story relative to the prior stories. If the new story is more important than the prior stories on similar/overlapping topics, the system 100 may assign a higher score to the new story than it assigned to the prior stories.

In general, this may lead to score creep, or score inflation, during the course of the day. Newer important stories need to be transmitted with higher scores than the prior stories on similar/overlapping topics, so that the newer stories may outrank prior stories. In an example, scores may be reset periodically, e.g., once per day in the middle of the night.

In certain examples, the system 100 may not run into difficulty to assign the right score value to a new story. If the system 100 receives a new story “C” that is more important than prior story “A”, but less important than prior story “B”, the system 100 tries to assign a score for “C” that is between the scores for “A” and “B.” If the score for B was higher than the score for A, then the system 100 assigns the score for “C” so that score(A)<score(C)<score(B).

Stories may overlap by varying amounts, and topics may come and go at different times and different rates. In certain circumstances, the system 100 may determine a new story “C” is more important than prior story “A” but less important than prior story “B”, yet story “A” had originally been assigned a higher score than “B.” An inconsistency results: the system 100 wants to assign a score to “C” so that score(C)<score(B) and score(C)>score(A), but this is impossible because score(A)>score(B).

The relevance server 105 may be configured to incorporate heuristics to handle these inconsistencies as well as possible with respect to assigning a score value to the new story.

In one example, the relevance server 105 may be configured to determine the score relationships only between the new story and its prior similar/overlapping stories. In one example, the relevance server 105 need not maintain relative score consistency across all prior stories—just across the stories on the topic(s) of the new story. This reduces the likelihood for score inconsistencies to arise.

In an example, the relevance server 105 may be configured to limit the score relationship computation to two bracketing stories—the currently lowest-scoring prior story whose “current” score is higher than that of the new story, and the currently highest-scoring story whose “current” score is lower than that of the new story. In an example, in case of an actual inconsistency remaining after the aforementioned steps, the relevance server 105 may be configured to assign the larger assigned score from those two prior stories to the new story, despite the inconsistency.

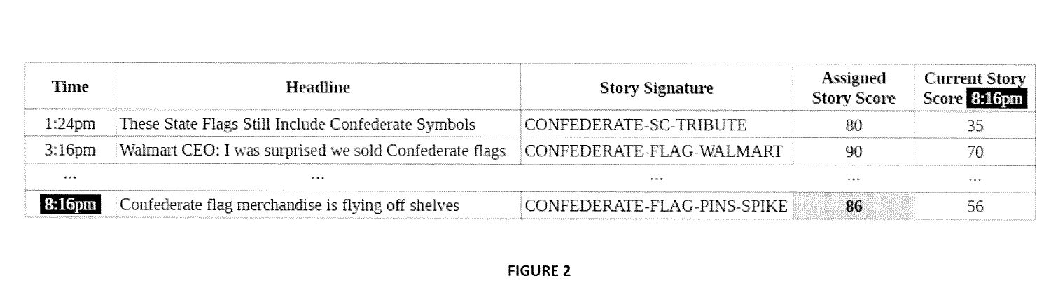

FIG. 2 is a table illustrating an example of assigning to a news story a score that maintains relative consistency with the scores assigned to prior news stories on a topic. FIG. 2 shows two stories that were sent in a feed: on a day at 1:24 PM and at 3:16 PM. One story was sent with an assigned score of 80, and another story was sent with an assigned score of 90.

At 8:16 PM a third story is received, and a score is computed, to be sent with the story in the feed. The prior stories that share story signature terms with this story are identified, specifically the two prior stories sharing the story signature term “CONFEDERATE”.

A current story score value is computed for each of these stories, based on the sum of the current term scores at 8:16 PM for the story signature terms in each story.

It is determined that the current story score value (56) for the new story at 8:16 PM is between the current story scores (35 and 70) for the two prior stories. The new story is then given an assigned story score (86) which is between the assigned story scores (80 and 90) for the two prior stories. In this example, the new assigned story score value is computed proportionally: (86−80)/(90−80)=(56−35)/(70−35).

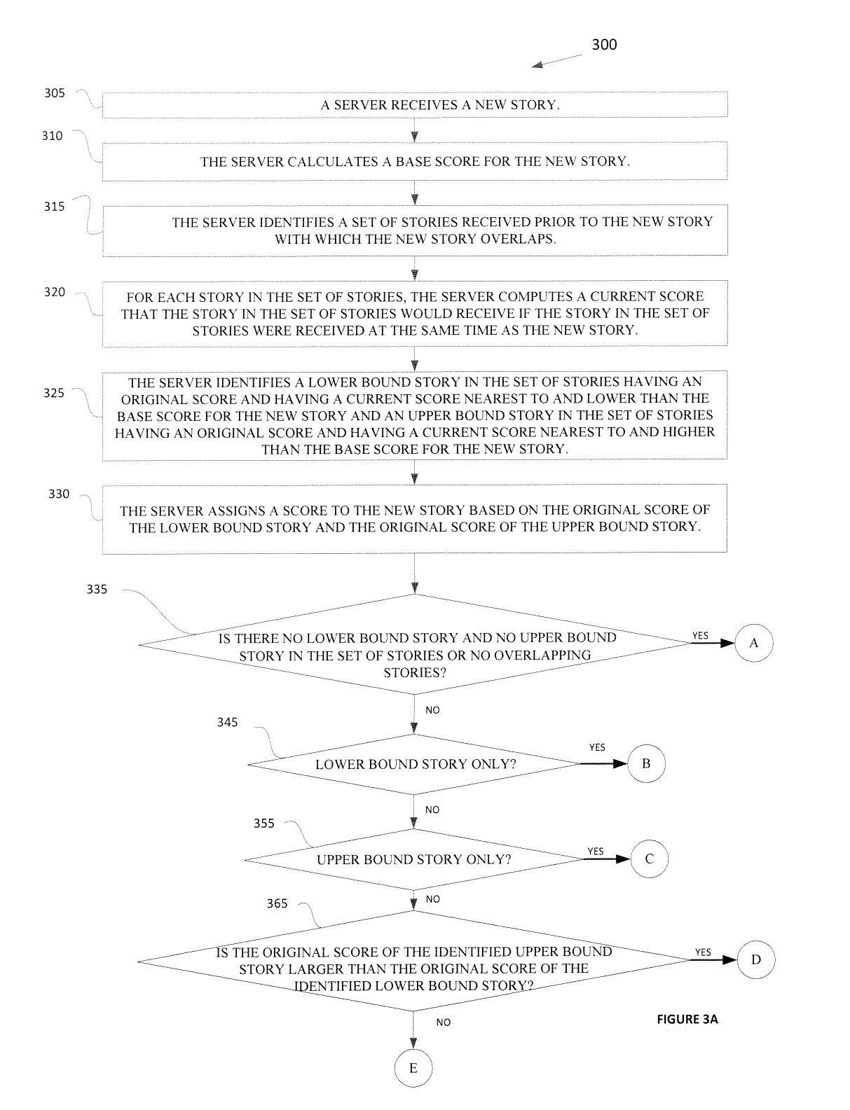

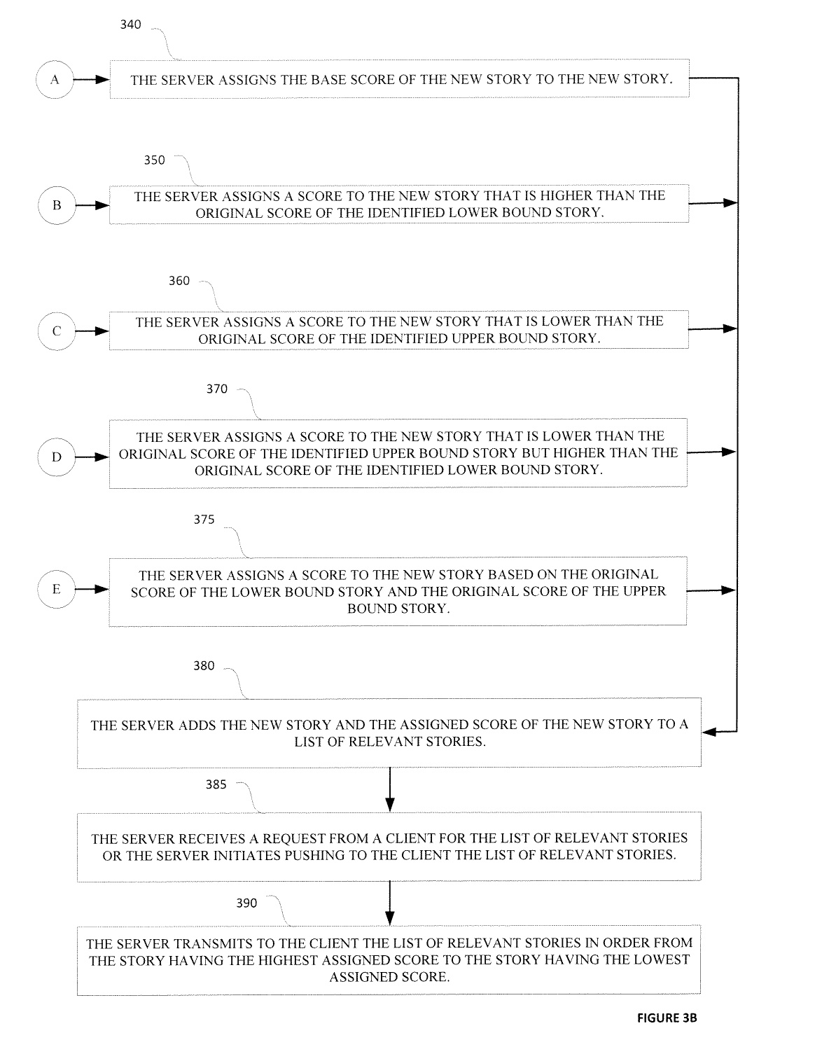

FIGS. 3A and 3B are a flow diagram illustrating an example of a method 300 to find currently relevant news stories 140 from a plurality of news feeds 110, 115 and arrange them into a list of stories 140 considered to be both newsworthy and relevant at the time of viewing, to be delivered to clients 130a-130n over a network 125. The method 300 may be performed by at least one processor of the relevance server 105 of FIG. 1 and may comprise hardware (e.g., circuitry, dedicated logic, programmable logic, microcode, etc.), software (e.g., instructions run on a processing device), or a combination thereof. In one example, the method 300 may be performed by processing logic 422 of the processor of the relevance server 105 of FIG. 1.

As shown in FIGS. 3A and 3B, at block 305, the server 105 may receive a new story. At block 310, the server 105 may calculate a base score for the new story. At block 315, the server 105 may identify a set of stories received prior to the new story with which the new story overlaps. At block 320, for each story in the set of stories, the server 105 may compute a current score that the story in the set of stories would receive if the story in the set of stories were received at the same time as the new story. At block 325, the server 105 may identify a lower bound story in the set of stories having an original score and having a current score nearest to and lower than the base score for the new story and an upper bound story in the set of stories having an original score and having a current score nearest to and higher than the base score for the new story. At block 330, the server 105 may assign a (e.g., relevance) score to the new story based on the original score of the lower bound story and the original score of the upper bound story.

At block 335, the server 105 may attempt to determine whether there are no identified stories in the set of stories that overlap with the new story, or determine that there is no lower bound story and no upper bound story even if there are stories in the set of stories that overlap with the new story. If, at block 335, the server 105 determines that there are no identified stories in the set of stories that overlap with the new story, or determines that there is no lower bound story and no upper bound story even if there are stories in the set of stories that overlap with the new story, then at block 340, the server 105 may assign the base score of the new story to the new story; otherwise, at block 345, the server 105 may attempt to determine whether there is an identified lower bound story but no identified upper bound story. If, at block 345, the server 105 determines that there is an identified lower bound story but no identified upper bound story, then at block 350, the server 105 may assign a score to the new story that is higher than the original score of the identified lower bound story; otherwise, at block 355, the server 105 may attempt to determines whether there is an identified upper bound story but no identified lower bound story. If, at block 355, the server 105 determines that there is an identified upper bound story but no identified lower bound story, then at block 360, the server 105 may assign a score to the new story that is lower than the original score of the identified upper bound story; otherwise, there is both a lower bound story and an upper bound story.

At block 365, when there is an identified upper bound story and an identified lower bound story, the server 105 may attempt to determine whether the original score of the identified lower bound story is larger than the original score of the identified upper bound story. If, at block 365, the server 105 determines that the original score of the identified upper bound story is larger than the original score of the identified lower bound story, then at block 370, the server 105 may assign a score to the new story that is lower than the original score of the identified upper bound story but higher than the original score of the identified lower bound story; otherwise, at block 375, the server 105 may assign a score to the new story based on the original score of the lower bound story and the original score of the upper bound story.

In another example, when there is an identified upper bound story and an identified lower bound story, and the original score of the identified lower bound story is larger than the original score of the identified upper bound story, the server 105 may assign a score to the new story that is the mean of the original score of the identified lower bound story and the original score of the upper bound story.

In an example, the server 105 attempting to identify a lower bound story and an upper bound story may further comprise the server 105 identifying all stories in the set of stories having an overlap with the new story. The server 105 may assign the score to the new story based on the original scores of the stories in the set of stories having an overlap with the new story.

In an example, the server 105 assigning a score to the new story based on the original score of the lower bound story and the original score of the upper bound story may further comprise the server 105 assigning a score to the new story based on a weighting function applied to the original score of the lower bound story and to the original score of the upper bound story.

At block 380, the server 105 may add the new story and the assigned score of the new story to a list of relevant stories 140. At block 385, the server 105 may receive a request from a client (e.g., 130a) for the list of relevant stories 140. In another example, the server 105 may initiate pushing to the client (e.g., 130a) the list of relevant news stories. In an example, the server 105 initiating pushing to the client (e.g., 130a) the list of relevant stories may be a scheduled event or triggered event.

At block 390, the server 105 may transmit to the client (e.g., 130a) the list of relevant stories 140 in order from the story having the highest assigned score to the story having the lowest assigned score.

In an example, the list of relevant stories 140 may pertain to a topic. In an example, the list of relevant stories 140 may be generated over a period of time (e.g., over the course of a day).

Word scores (and hence story base scores) may be calculated from the frequency (increment and decay) of the signature terms in the driver feeds, and the stories sent to the clients (e.g., 130a-130n) are in the candidate feeds.

In an example, a score for a story may be calculated or assigned based on a plurality of terms appearing most prominently in the story. In an example, the score for the story may be equal to a score corresponding to scores of the sum of the plurality of terms appearing most prominently in the story.

In an example, an overlap between the new story and a story in the set of stories may be an overlap of one or more terms in a set of key terms appearing most prominently in the new story and the story in the set of stories.

In an example, a score for a term appearing most prominently in a story may be decreased each time a story is received.

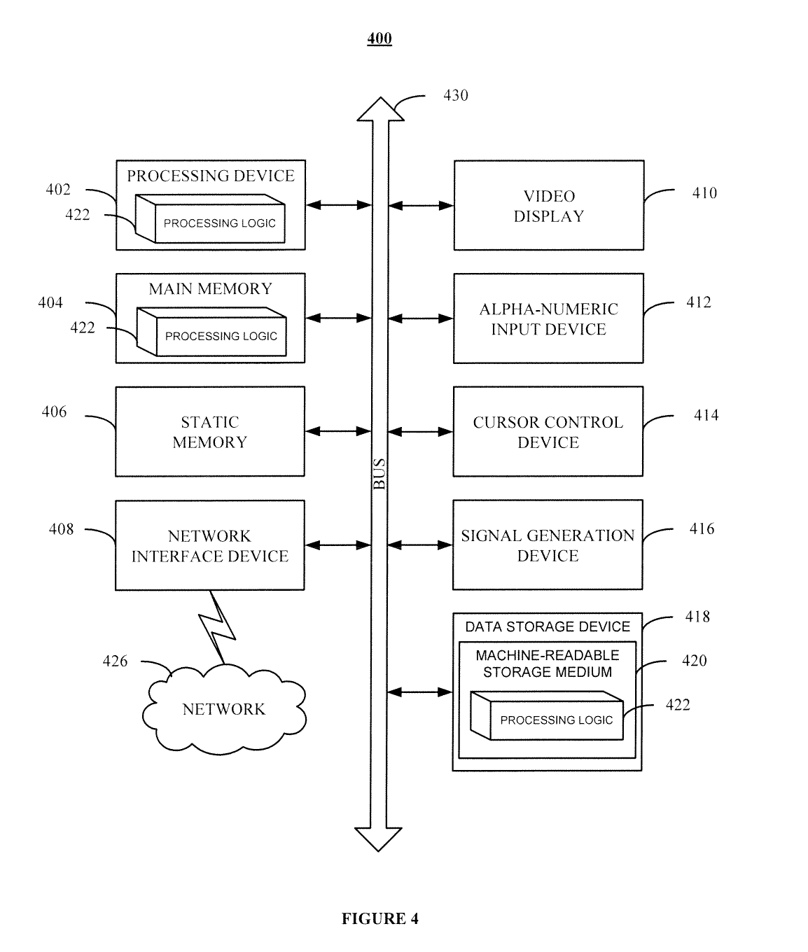

FIG. 4 illustrates a diagrammatic representation of a machine in the exemplary form of a computer system 400 within which a set of instructions, for causing the machine to perform any one or more of the methodologies discussed herein, may be executed. In alternative embodiments, the machine may be connected (e.g., networked) to other machines in a local area network (LAN), an intranet, an extranet, or the Internet. The machine may operate in the capacity of a server or a client machine in a client-server network environment, or as a peer machine in a peer-to-peer (or distributed) network environment. The machine may be a personal computer (PC), a tablet PC, a set-top box (STB), a personal digital assistant (PDA), a cellular telephone, a web appliance, a server, a network router, switch or bridge, or any machine capable of executing a set of instructions (sequential or otherwise) that specify actions to be taken by that machine. Further, while only a single machine is illustrated, the term “machine” shall also be taken to include any collection of machines that individually or jointly execute a set (or multiple sets) of instructions to perform any one or more of the methodologies discussed herein.

The exemplary computer system 400 includes a processing device 402, a main memory 404 (e.g., read-only memory (ROM), flash memory, dynamic random access memory (DRAM) (such as synchronous DRAM (SDRAM) or Rambus DRAM (RDRAM), etc.), a static memory 406 (e.g., flash memory, static random access memory (SRAM), etc.), and a data storage device 418, which communicate with each other via a bus 430.

Processing device 402 represents one or more general-purpose processing devices such as a microprocessor, central processing unit, or the like. More particularly, the processing device may be complex instruction set computing (CISC) microprocessor, reduced instruction set computer (RISC) microprocessor, very long instruction word (VLIW) microprocessor, or processor implementing other instruction sets, or processors implementing a combination of instruction sets. Processing device 402 may also be one or more special-purpose processing devices such as an application specific integrated circuit (ASIC), a field programmable gate array (FPGA), a digital signal processor (DSP), network processor, or the like. Processing device 402 is configured to execute processing logic 422 for performing the operations and steps discussed herein.

Computer system 400 may further include a network interface device 408. Computer system 400 also may include a video display unit 410 (e.g., a liquid crystal display (LCD) or a cathode ray tube (CRT)), an alphanumeric input device 412 (e.g., a keyboard), a cursor control device 414 (e.g., a mouse), and a signal generation device 416 (e.g., a speaker).

Data storage device 418 may include a machine-readable storage medium (or more specifically a computer-readable storage medium) 420 having one or more sets of instructions embodying any one or more of the methodologies of functions described herein. Device logic of may also reside, completely or at least partially, within main memory 404 and/or within processing device 402 during execution thereof by computer system 400; main memory 404 and processing device 402 also constituting machine-readable storage media. Processing logic 422 may further be transmitted or received over a network 426 via network interface device 408.

Machine-readable storage medium 420 may also be used to store the processing logic 422 persistently. While machine-readable storage medium 420 is shown in an exemplary embodiment to be a single medium, the term “machine-readable storage medium” should be taken to include a single medium or multiple media (e.g., a centralized or distributed database, and/or associated caches and servers) that store the one or more sets of instructions. The term “machine-readable storage medium” shall also be taken to include any medium that is capable of storing or encoding a set of instruction for execution by the machine and that causes the machine to perform any one or more of the methodologies of the present invention. The term “machine-readable storage medium” shall accordingly be taken to include, but not be limited to, solid-state memories, and optical and magnetic media.

The components and other features described herein can be implemented as discrete hardware components or integrated in the functionality of hardware components such as ASICs, FPGAs, DSPs or similar devices. In addition, these components can be implemented as firmware or functional circuitry within hardware devices. Further, these components can be implemented in any combination of hardware devices and software components.

Some portions of the detailed descriptions are presented in terms of algorithms and symbolic representations of operations on data bits within a computer memory. These algorithmic descriptions and representations are the means used by those skilled in the data processing arts to most effectively convey the substance of their work to others skilled in the art. An algorithm is here, and generally, conceived to be a self-consistent sequence of steps leading to a desired result. The steps are those requiring physical manipulations of physical quantities. Usually, though not necessarily, these quantities take the form of electrical or magnetic signals capable of being stored, transferred, combined, compared, and otherwise manipulated. It has proven convenient at times, principally for reasons of common usage, to refer to these signals as bits, values, elements, symbols, characters, terms, numbers, or the like.

It should be borne in mind, however, that all of these and similar terms are to be associated with the appropriate physical quantities and are merely convenient labels applied to these quantities. Unless specifically stated otherwise, as apparent from the above discussion, it is appreciated that throughout the description, discussions utilizing terms such as “enabling”, “transmitting”, “requesting”, “identifying”, “querying”, “retrieving”, “forwarding”, “determining”, “passing”, “processing”, “disabling”, or the like, refer to the action and processes of a computer system, or similar electronic computing device, that manipulates and transforms data represented as physical (electronic) quantities within the computer system's registers and memories into other data similarly represented as physical quantities within the computer system memories or registers or other such information storage, transmission or display devices.

Embodiments of the present invention also relate to an apparatus for performing the operations herein. This apparatus may be specially constructed for the required purposes or it may comprise a general purpose computer selectively activated or reconfigured by a computer program stored in the computer. Such a computer program may be stored in a computer readable storage medium, such as, but not limited to, any type of disk including floppy disks, optical disks, CD-ROMs and magnetic-optical disks, read-only memories (ROMs), random access memories (RAMs), EPROMs, EEPROMs, magnetic or optical cards, flash memory devices including universal serial bus (USB) storage devices (e.g., USB key devices) or any type of media suitable for storing electronic instructions, each of which may be coupled to a computer system bus.

The algorithms and displays presented herein are not inherently related to any particular computer or other apparatus. Various general purpose systems may be used with programs in accordance with the teachings herein or it may prove convenient to construct more specialized apparatus to perform the required method steps. The required structure for a variety of these systems will be apparent from the description above. In addition, the present invention is not described with reference to any particular programming language. It will be appreciated that a variety of programming languages may be used to implement the teachings of the invention as described herein.

It is to be understood that the above description is intended to be illustrative, and not restrictive. Many other examples will be apparent to those of skill in the art upon reading and understanding the above description. The scope of the disclosure should, therefore, be determined with reference to the appended claims, along with the full scope of equivalents to which such claims are entitled.

1. A method, comprising:
receiving, by a server, a new story;
calculating, by a server, a base score for the new story;
identifying, by the server, a set of stories received prior to the new story with which the new story overlaps, wherein each of the set of stories has been assigned a score that has decayed over a time interview due to the publication of related stories over the time interval;
for each story in the set of stories, computing, by the server, a current score that the story in the set of stories would receive if the story in the set of stories were received at the same time as the new story, wherein the current score is indicative of publication after the time interval has expired;
identifying, by the server, a lower bound story in the set of stories having an original score and having a current score nearest to and lower than the base score for the new story and an upper bound story in the set of stories having an original score and having a current score nearest to and higher than the base score for the new story; and
assigning, by the server, a score to the new story based on the current score of the lower bound story and the current score of the upper bound story.

2. The method of claim 1, wherein,
when there are no identified stories in the set of stories that overlap with the new story,
assigning, by the server, the base score of the new story to the new story.

3. The method of claim 1, wherein,
when there is an identified lower bound story but no identified upper bound story,
assigning, by the server, a score to the new story that is higher than the current score of the identified lower bound story.

4. The method of claim 1, wherein,
when there is an identified upper bound story but no identified lower bound story,
assigning, by the server, a score to the new story that is lower than the current score of the identified upper bound story.

5. The method of claim 1, wherein,
when there is an identified upper bound story and an identified lower bound story, and the original score of the identified upper bound story is larger than the current score of the identified lower bound story,
assigning, by the server, a score to the new story that is lower than the current score of the identified upper bound story but higher than the current score of the identified lower bound story.

6. The method of claim 1, wherein,
when there is an identified upper bound story and an identified lower bound story, and a current score of the identified lower bound story is larger than a current score of the identified upper bound story,
assigning, by the server, a score to the new story that is larger than the current score of the identified lower bound story.

7. The method of claim 1, wherein,
when there is an identified upper bound story and an identified lower bound story, and a current score of the identified lower bound story is larger than a current score of the identified upper bound story,
assigning, by the server, a score to the new story that is the mean of the current score of the identified lower bound story and the current score of the upper bound story.

8. The method of claim 1, wherein attempting to identify, by the server, a lower bound story and an upper bound story further comprises:
identifying, by the server, all stories in the set of stories having an overlap with the new story; and
assigning, by the server, the score to the new story based on the current scores of the stories in the set of stories having an overlap with the new story.

9. The method of claim 1, wherein assigning, by the server, a score to the new story based on the original score of the lower bound story and the current score of the upper bound story further comprises assigning, by the server, a score to the new story based on a weighting function applied to the current score of the lower bound story and to the original score of the upper bound story.

10. The method of claim 1, further comprising, adding, by the server, the new story and the assigned score of the new story to a list of relevant stories.

11. The method of claim 10, further comprising:
receiving, by the server, a request from a client for the list of relevant stories or the server initiates pushing to the client the list of relevant stories; and
transmitting, by the server to the client, the list of relevant stories in order from the story having the highest assigned score to the story having the lowest assigned score.

12. The method of claim 10, wherein the list of relevant stories pertain to a topic.

13. The method of claim 10, wherein the list of relevant stories is generated over a period of time.

14. The method of claim 10, wherein the list of relevant stories is taken from a set of low cost or free news feeds.

15. The method of claim 10, wherein the received prior set of stories are taken from a set of premium cost news feeds.

16. The method of claim 1, wherein a score for a story is calculated or assigned based on a plurality of terms appearing most prominently in the story.

17. The method of claim 16, wherein the score for the story is equal to a score corresponding to scores of the sum of the plurality of terms appearing most prominently in the story.

18. The method of claim 1, wherein an overlap between the new story and a story in the set of stories is an overlap of one or more terms in a set of key terms appearing most prominently in the new story and the story in the set of stories.

19. The method of claim 1, wherein a score for a term appearing most prominently in a story is decreased each time a story is received.

20. A system, comprising:
a memory;
a server, operatively coupled to the memory, the server to:
receive a new story;
calculate a base score for the new story;
identify a set of stories received prior to the new story with which the new story overlaps, wherein each of the set of stories has been assigned a score that has decayed over a time interview due to the publication of related stories over the time interval;
for each story in the set of stories, compute a current score that the story in the set of stories would receive if the story in the set of stories were received at the same time as the new story, wherein the current score is indicative of publication after the time interval has expired;
identify a lower bound story in the set of stories having an original score and having a current score nearest to and lower than the base score for the new story and an upper bound story in the set of stories having an original score and having a current score nearest to and higher than the base score for the new story; and
assign a score to the new story based on the current score of the lower bound story and the current score of the upper bound story.

21. The system of claim 20, wherein,
when there is an identified upper bound story and an identified lower bound story, and the current score of the identified upper bound story is larger than the current score of the identified lower bound story,
assign a score to the new story that is lower than the current score of the identified upper bound story but higher than the current score of the identified lower bound story.

22. The system of claim 20, wherein,
when there is an identified upper bound story and an identified lower bound story, and a current score of the identified lower bound story is larger than a current score of the identified upper bound story,
assign a score to the new story that is larger than the current score of the identified lower bound story.

23. A non-transitory computer readable storage medium including instructions that, when executed by a server, cause the server to:
receive, by a server, a new story;
calculate, by the server, a base score for the new story;
identify, by the server, a set of stories received prior to the new story with which the new story overlaps, wherein each of the set of stories has been assigned a score that has decayed over a time interview due to the publication of related stories over the time interval;
for each story in the set of stories, compute, by the server, a current score that the story in the set of stories would receive if the story in the set of stories were received at the same time as the new story, wherein the current score is indicative of publication after the time interval has expired;
identify, by the server, a lower bound story in the set of stories having an original score and having a current score nearest to and lower than the base score for the new story and an upper bound story in the set of stories having an original score and having a current score nearest to and higher than the base score for the new story; and
assign, by the server, a score to the new story based on the current score of the lower bound story and the current score of the upper bound story.

24. The non-transitory computer readable storage medium of claim 23, wherein the server is further to,
when there is an identified upper bound story and an identified lower bound story, and the current score of the identified upper bound story is larger than the current score of the identified lower bound story,
assign, by the server, a score to the new story that is lower than the current score of the identified upper bound story but higher than the current score of the identified lower bound story.

25. The non-transitory computer readable storage medium of claim 23, wherein the server is further to,
when there is an identified upper bound story and an identified lower bound story, and a current score of the identified lower bound story is larger than a current score of the identified upper bound story,
assign, by the server, a score to the new story that is larger than the current score of the identified lower bound story.
